(19) United States
(12) Patent Application Publication
(10) Pub. No.: US 2016/0313945 A1
(43) Pub. Date: Oct. 27, 2016

(54) STORAGE APPARATUS, CONTROLLING METHOD AND COMPUTER READABLE MEDIUM

(71) Applicant: FUJITSU LIMITED, Kawasaki-shi (JP)

(72) Inventor: Ken IIZAWA, Yokohama (JP)

(73) Assignee: FUJITSU LIMITED, Kawasaki-Shi (JP)

(21) Appl. No.: 15/084,767

(22) Filed: Mar. 30, 2016

(30) Foreign Application Priority Data
Apr. 22, 2015 (JP) 2015-087977

(51) Int. Cl. G06F 3/06

(52) U.S. Cl. CPC G06F 3/0659; G06F 3/061; G06F 3/0658; G06F 3/067; G06F 3/068

(57) ABSTRACT

A storage apparatus includes a plurality of disk apparatuses, a memory including a read buffer, and a processor. The processor is configured to perform a writing process, the writing process including writing a plurality of pieces of divided data into the plurality of disk apparatuses, interrupt, when a readout request for reading out series of data from the plurality of disk apparatuses is received during execution of the writing process, the writing process to a predetermined number of disk apparatuses from among the plurality of disk apparatuses, read out the pieces of data requested by the readout request from the predetermined number of disk apparatuses, store the read out pieces of data into the read buffer, reconstruct the pieces of data stored in the read buffer back into the series of data requested by the readout request, and output the reconstructed data.

### CROSS-REFERENCE TO RELATED APPLICATION

This application is based upon and claims the benefit of priority of the prior Japanese Patent Application No. 2015-087977, filed on Apr. 22, 2015, the entire contents of which are incorporated herein by reference.

### FIELD

The present embodiment relates to a storage apparatus, a controlling method, and a computer readable medium.

### BACKGROUND

A storage server is available wherein stream data (data of an indefinite length that flows on a network and arrives in a chronological order) received through a network are accumulated into a mass storage apparatus formed from a disk storage such as a hard disk drive (HDD). The storage server temporarily stores, for example, a series of stream data distributed successively thereto into a buffer in a memory and writes, when the amount of the data stored in the buffer reaches a fixed amount, the data into a storage device such as an HDD. When the writing speed into the storage device such as an HDD is lower than the reception speed of the stream data, the storage server performs, in order to achieve higher speed accessing to the storage device, a process of dividing the stream data and writing the divisional stream data in parallel to a plurality of HDDs (also called “striping”).

As a technology for accumulating stream data, a technology is known by which loss of data by exhaustion of the bandwidth is prevented by dynamically managing requirements for the bandwidth of a digital recording system by which stream data are stored. Also a technology is known wherein a plurality of stream data are recorded and reproduced simultaneously while the redundancy of recorded data is secured by recording stream data in a duplicated fashion into two data recording apparatuses.

As an example of a related art document, Japanese National Publication of International Patent Application No. 2003-533843 and Japanese Laid-open Patent Publication No. 2007-281972 are known.

### SUMMARY

According to an aspect of the invention, a storage apparatus includes a plurality of disk apparatuses, a memory including a read buffer, and a processor. The processor is configured to perform a writing process, the writing process including writing a plurality of pieces of divided data into the plurality of disk apparatuses, interrupt, when a readout request for reading out series of data from the plurality of disk apparatuses is received during execution of the writing process, the writing process to a predetermined number of disk apparatuses from among the plurality of disk apparatuses, read out the pieces of data requested by the readout request from the predetermined number of disk apparatuses, store the read out pieces of data into the read buffer, reconstruct the pieces of data stored in the read buffer back into the series of data requested by the readout request, and output the reconstructed data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts an example of a configuration of a storage system to which an embodiment is applied;

FIG. 2 depicts an example of a configuration of a storage server;

FIG. 3 is a functional block diagram of software for controlling a storage server;

FIG. 4 is a view illustrating writing operation of data into a storage server that includes a plurality of HDDs;

FIG. 5 is a view illustrating operation for reading out from a plurality of HDDs during writing into a plurality of HDDs;

FIG. 6 is a view illustrating operation of a working example of the present embodiment;

FIG. 7 depicts an example of a configuration of a writable HDD table;

FIG. 8 depicts an example of a configuration of a data management table;

FIG. 9 illustrates a state of a data management table after a reading out process is performed;

FIG. 10 illustrates a state of a data management table after a different reading out process is performed after the reading out process of FIG. 9;

FIG. 11 is a flow chart of a process for accumulating data into a write buffer from within a process for a request for writing;

FIG. 12 is a flow chart of a process for writing data from a write buffer into HDDs from within a process for a request for writing; and

FIG. 13 is a flow chart illustrating a process for a request for reading out.

### DESCRIPTION OF EMBODIMENT

An HDD of a large-scale capacity that stores stream data sometimes undergoes different control from that performed for an HDD for common personal computers (PCs). For example, access to an HDD is sometimes controlled directly without generating a file system or access control to an HDD is sometimes performed by generating a huge file on a file system. Since access to a disk recording medium such as an HDD is performed after a magnetic head is moved to a track on which data of an access destination are stored, when access for writing and access for reading out, in which the access destinations are different from each other, are to be changed over, a delay occurs due to a movement of the magnetic head and so forth. Therefore, if reading out access to an HDD is performed frequently while writing access is being performed for the same HDD, then the writing performance is degraded.

In the case of a storage server in which stream data are accumulated, the degradation of the writing performance immediately gives rise to loss of data, and therefore, degradation of the writing performance is unacceptable. Therefore, a readout request is processed to such a degree that the process does not exert an influence on the writing performance. As a result, the reading out time is elongated.

For example, batch processing or the like for reading out and analyzing stream data received within a certain period of time is sometimes performed while divided data are being written into a plurality of HDDs. In this case, in order not to exert an influence on writing of the stream data into the HDDs, for example, reading out of data is performed utilizing a period of time after the stream data are written into the plurality of HDDs until stream data to be written subsequently are stored into a buffer in a memory. Then, after received stream data are accumulated fully in the buffer in the memory, writing into the plurality of HDDs is started again. However, if writing into and reading out from the plurality of HDDs are repeated frequently, then since waiting time is generated by movement of the magnetic head and so forth, there is a subject that the reading out time becomes long.

According to one aspect of the present embodiment, it is desirable to improve the reading out performance from a storage apparatus when writing and reading out of stream data are competitive.

In the following, an embodiment of a storage system is described with reference to the accompanying drawings. The configuration of the embodiment described below is exemplary, and the embodiment is not limited to that including the configuration described below.

The storage apparatus of the present embodiment accumulates stream data received through a network into a mass storage device such as an HDD. Here, in the present embodiment, the stream data are data of an indefinite length which flow on the network and arrive in a chronological order. The stream data are not limited to continuous content data of music, a movie or the like and include packet data or the like of an indefinite length flowing on the network.

As an application of the storage apparatus disclosed below, an application is assumed which stores data such as, for example, video data of a security camera or remote sensing sensor data over a fixed period (for example, over several days to several weeks or more) in the past and reads out the data by setting a suitable period for which the data may be used. Also a different application is assumed which stores operational information indicative of a state of operational environments or the like of equipment of a data center or the like in a time series and analyzes, when some trouble or the like occurs, the operational information retrospectively to find out the cause of the trouble.

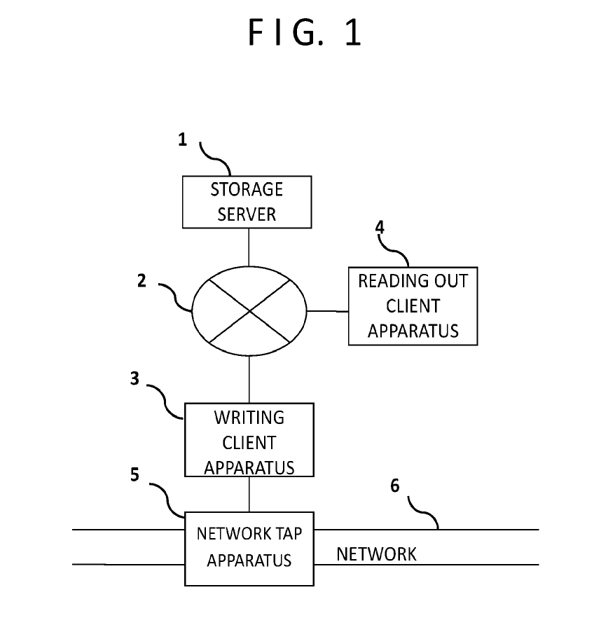

FIG. 1 is a view depicting an example of a configuration of a storage system according to the embodiment. The storage server 1 is an example of a storage apparatus and is coupled to a writing client apparatus 3 and a reading out client apparatus 4 through a network 2 such as a local area network (LAN). The writing client apparatus 3 is coupled to a network tap apparatus 5 that takes out stream data flowing through a wide-area network 6.

The network tap apparatus 5 almost always monitors the network 6 and branches and takes out stream data flowing on the network 6. As an acquisition method of data by the network tap apparatus 5, for example, all data packets of stream data flowing on the network 6 may be taken out or particular data packets having a given destination address or a transmission source address may be taken out. The network tap apparatus 5 transmits the taken out data packets to the writing client apparatus 3 together with information of time at which the data packets branched and taken out from the network 6 are acquired.

The writing client apparatus 3 performs division and reconstruction of the data packets received from the network tap apparatus 5 as occasion demands and transmits the divided and reconstructed data packets to the storage server 1 together with a write request through the network 2. If a data packet received from the network tap apparatus 5 indicates long data of an indefinite length, then the writing client apparatus 3 may convert or divide the data into data of a fixed length and then transmit the resulting data to the storage server 1.

The reading out client apparatus 4 transmits a readout request to the storage server 1 through the network 2 in accordance with a readout request sent thereto at any time from a terminal (not depicted) of a user of the storage server 1 and then transmits readout data read out from the storage server 1 back to the terminal of the user of the requesting source. Usually, while a write request from the writing client apparatus 3 is generated successively or in a high frequency, a readout request from the reading out client apparatus 4 is generated sporadically as a request that designates a particular range of time (year, month, day, hour, minute and second).

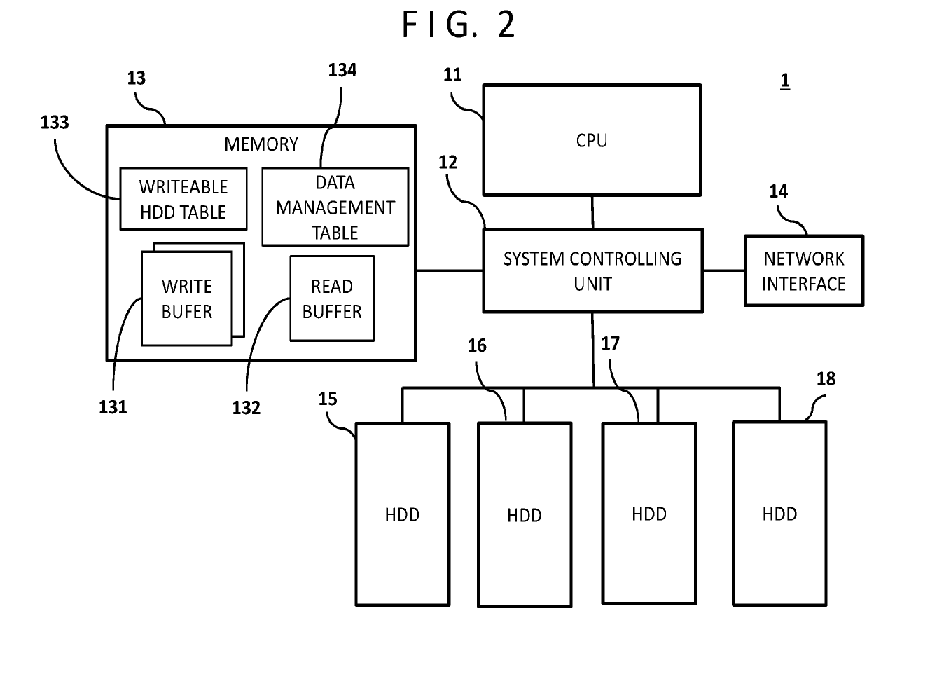

FIG. 2 is a view depicting an example of a configuration of a storage server. The storage server depicted in FIG. 2 may be the storage server 1 depicted in FIG. 1. The storage server 1 includes a central processing unit (CPU) 11, a system controlling unit 12, a memory 13, HDDs 15 to 18 as a plurality of disk storages, and a network interface 14 for coupling with the network 2. The system controlling unit 12 controls data transfer among the CPU 11, the memory 13, the network interface 14 and the HDDs 15 to 18 and includes an interface circuit for the HDDs 15 to 18 and an interface circuit for the memory 13. While FIG. 2 depicts an example in which the storage server 1 includes four HDDs, the number of HDDs is not limited to four but may be an arbitrary number.

The memory 13 includes a storage region for a write buffer 131, another storage region for a read buffer 132, a further storage region for a writable HDD table 133 and a still further storage region for a data management table 134. The write buffer 131 is a storage region for temporarily storing therein write data sent from the writing client apparatus 3. The read buffer 132 is a storage region for temporarily storing readout data read out from the HDDs 15 to 18 in accordance with a readout request from the reading out client apparatus 4. Details of the writable HDD table 133 and the data management table 134 are hereinafter described.

The memory 13 may be configured such that the memory 13 includes a plurality of write buffers 131. In particular, it is possible to provide, in the memory 13, a write buffer for accumulating received stream data and another write buffer for retaining, while a process for dividing received data into units of a stripe and writing the divided data into a plurality of HDDs is being performed, the data to be written into the HDDs. By the configuration just described, a writing process by striping into the plurality of HDDs 15 to 18 and a process for accumulating received stream data can be performed in parallel.

Though not depicted in FIG. 2, also a program to be executed by the CPU 11, data to be used in a process executed by the CPU 11 and so forth are stored in the memory 13. The CPU 11 is an example of a “control unit” or a “processor.” The CPU 11 executes a program not depicted stored in the memory 13 to perform control of the entire storage server 1. In particular, the CPU 11 controls writing and reading out of stream data into and from the HDDs 15 to 18 on the basis of information of the writable HDD table 133 and/or the data management table 134.

It is to be noted that the read buffer 132 may be provided not in the memory 13 but in a different storage device such as an HDD for exclusive use for the buffer, and also the write buffer 131 may be provided in a different high-speed storage device. Further, although a mass storage device of a different type can be used in place of the HDDs 15 to 18, in the present embodiment, noticeable effects are exhibited in the case of a disk storage apparatus of the access type that involves mechanical movement of a head for performing reading and writing such as a magneto-optical disk or an optical disk.

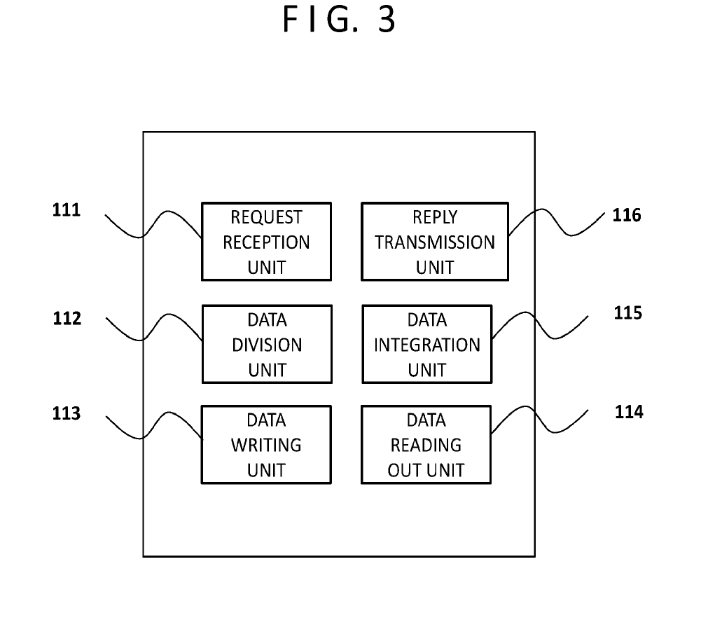

FIG. 3 is a functional block diagram of software for controlling a storage server. The storage server depicted in FIG. 3 may be the storage server 1 depicted in FIG. 1. The software for controlling the storage server 1 includes a request reception unit 111, a data division unit 112, a data writing unit 113, a data reading out unit 114, a data integration unit 115 and a reply transmission unit 116. A control program for the functional blocks (111 to 116) is stored, for example, in the memory 13 or a storage device not depicted in FIG. 2 such as a nonvolatile memory or an HDD. Processing of the functional blocks is performed by the CPU 11 reading out and executing a control program for the functional blocks stored in the memory 13 or the like.

The request reception unit 111 receives a write request from the writing client apparatus 3 or a readout request from the reading out client apparatus 4. If the received request is a write request from the writing client apparatus 3, then the request reception unit 111 receives, together with the write request, write data, namely, a data packet of stream data processed by the writing client apparatus 3 or the like. The request reception unit 111 stores the received write data into the write buffer 131. If the request reception unit 111 receives a readout request from the reading out client apparatus 4, then the request reception unit 111 instructs the data reading out unit 114 to perform a reading out process of the received readout request.

The data division unit 112 divides, after data of a fixed amount are stored into the write buffer 131, the data stored in the write buffer 131 into data of units of a stripe to be used upon writing the data into a plurality of HDDs by striping.

The data writing unit 113 refers to the writable HDD table 133 to specify writable HDDs from among the plurality of HDDs 15 to 18. The data writing unit 113 performs a process for writing the data divided by the data division unit 112 into the specified writable HDDs.

If the data reading out unit 114 receives a readout request from the reading out client apparatus 4, then the data reading out unit 114 refers to the data management table 134 to specify the HDDs in which data of a reading out target are stored. Then, the data reading out unit 114 designates, from among the specified HDDs, part of HDD for a reading out target HDD and performs a reading out process of reading out the data of the reading out target from the designated HDD and storing the readout data into the read buffer 132. The part of data reading out unit 114 successively changes the HDD for which the reading out process is to be performed and reads out the data of the reading out target from all of the HDDs in which the reading out target data are stored to store the readout data in the read buffer 132.

The data integration unit 115 re-arranges and integrates the data stored in the read buffer 132 on the basis of time information of the data acquired from the data management table 134 by the data reading out unit 114. In other words, the data integration unit 115 creates data by reconstructing the data read out from the plurality of HDDs 15 to 18 into the read buffer 132 so as to have a state before the striping. The reply transmission unit 116 transmits the data integrated by the data integration unit 115 to the reading out client apparatus 4 that is the request source of the readout request.

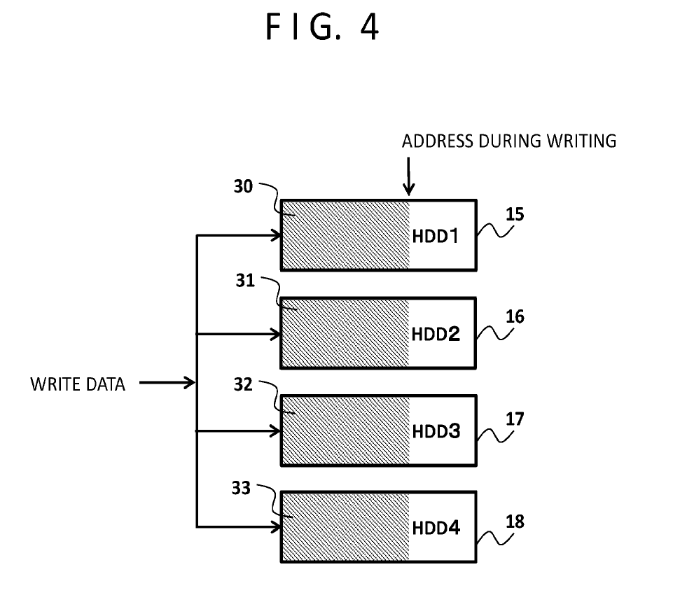

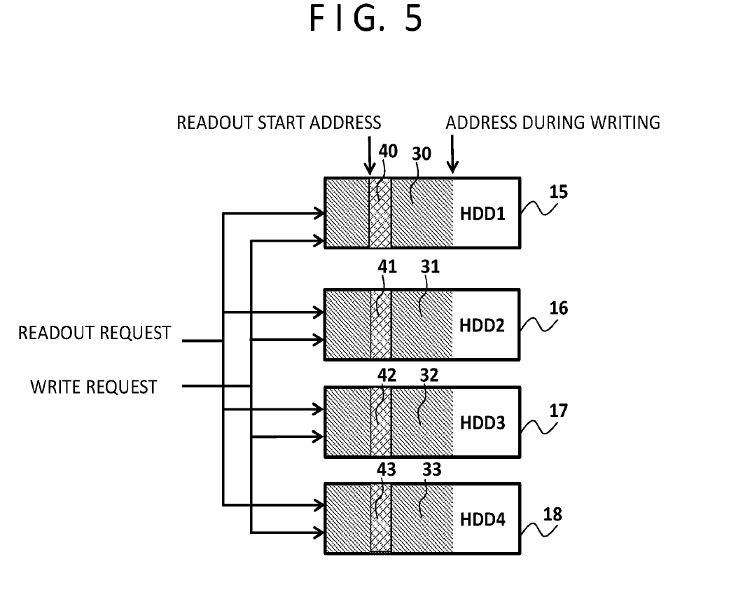

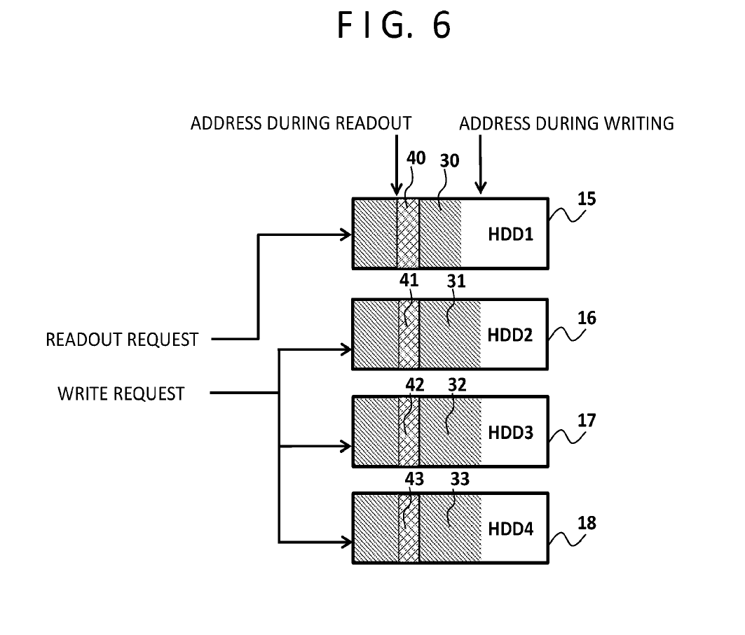

FIG. 4 is a view illustrating writing operation of data into a storage server that includes a plurality of HDDs. The storage server depicted in FIG. 4 may be the storage server 1 depicted in FIG. 1. In FIG. 4, an example is depicted in which write data from the writing client apparatus 3 are divided and written in parallel into the four HDDs 15 to 18. In FIG. 4, the components of the storage server 1 other than the HDDs 15 to 18 are omitted (this similarly applies also to FIGS. 5 and 6).

In FIG. 4, slanting line portions 30 to 33 indicate regions in which data are written already, and blank portions indicate regions in which data are to be written later or to be overwritten. Into regions of the HDDs 15 to 18 indicated by “address during writing,” a writing process of data is performed in parallel in units of a stripe obtained by dividing the data stored in the write buffer 131. The writing processes for the HDDs 15 to 18 are sequentially performed. It is to be noted that, although the plurality of HDDs 15 to 18 need not operate in a strictly synchronized relationship with each other, the plurality of HDDs 15 to 18 operate in parallel every time a given amount of data is accumulated into the write buffer 131. If data are written into the overall storage regions of the HDDs 15 to 18, then new data are overwritten into the regions in which data are written already beginning with the top address of the storage regions of the HDDs 15 to 18.

FIG. 5 is a view illustrating operation for reading out from a plurality of HDDs during writing into a plurality of HDDs. FIG. 5 illustrates operation of reading out by a known method when a readout request for reading out target data 40 to 43 included in the four HDDs 15 to 18 during a writing process of data into the HDDs 15 to 18 for comparison with the present embodiment. In the storage server 1 that accumulates stream data, a writing process is performed preferentially to a reading out process in order not to miss the data to be accumulated. Therefore, if a writing process and a reading out process of data into and from the storage server 1 are competitive, then reading out is performed making use of a surplus time period such as a period of time within which the write data are being accumulated into the write buffer 131 after writing of stripe data is performed. In the example of FIG. 5, a writing process is performed in parallel for the four HDDs 15 to 18, and a reading out process is performed in parallel for the four HDDs 15 to 18.

Generally, since a write address and a read address are different from each other, when the surplus time period described above starts, the magnetic head of each HDD is moved once from a write position to a read position and then a reading out process is performed, and a time period for returning the magnetic head to the write position before time of an end of the surplus time period is required. Substantially only part of the surplus time period can be used for the reading out process because the time period for moving the magnetic head or the like is required. Accordingly, a reading out process that utilizes a time period shorter than the surplus time period is repeated many times, and a long period of time is required for processing of the readout request.

It is to be noted that, also in a case in which data are read out in parallel from all of the HDDs 15 to 18 in the reading out process of FIG. 5, the accurate reading out timings of the HDDs differ depending upon various conditions. For example, the data reading out timings from the HDDs do not coincide with each other from reasons that the relative position between the physical position of the readout request address on the disk and the magnetic head in a circumferential direction differs among the HDDs, that whether or not a replacement process for a defective track is to be performed differs among the HDDs and so forth. Therefore, the readout data are reconstructed on the time base in the read buffer 132, and the data reconstructed on the time base are sent back to the reading out client apparatus 4.

FIG. 6 is a view illustrating operation of a working example of the present embodiment. In the description given below with reference to FIG. 6 and the succeeding figures, in order to simplify description, it is assumed that the number of HDDs is four and the flow rate of stream data flowing on the network 6 is 12 [MB/s] while both of the maximum writing performance and the maximum reading out performance of each HDD are 4 [MB/s]. In this case, theoretically it is possible for three HDDs to store the stream data without missing thereof, and a surplus performance for one HDD is provided.

The example depicted in FIG. 6 is, different from the example of FIG. 5, an example wherein the reading out process in accordance with a readout request is performed not simultaneously in parallel from the four HDDs 15 to 18 but from one by one of the four HDDs 15 to 18 (in FIG. 6, from, the HDD 15). In other words, while the stream data of 12 [MB/s] are divided and written by a maximum writing performance for three HDDs, a reading out process of data is performed for the remaining one HDD.

In particular, while a writing process for the HDD 15 is interrupted and a reading out process is executed for the HDD 15, a writing process of data is performed into the remaining three HDDs 16 to 18. If the reading out process of a fixed amount of data from the HDD 15 is completed, then the HDD 15 returns to the writing process, and the HDD 16 subsequently interrupts a writing process and executes a reading out process. Therefore, the HDD from which data are to be read out is successively changed one by one to perform a reading out process similarly. Since the reading out process from the HDDs can be performed continuously, frequent movements of the magnetic heads in the example of FIG. 5 are unnecessary, and the reading out processing speed from each HDD can be improved.

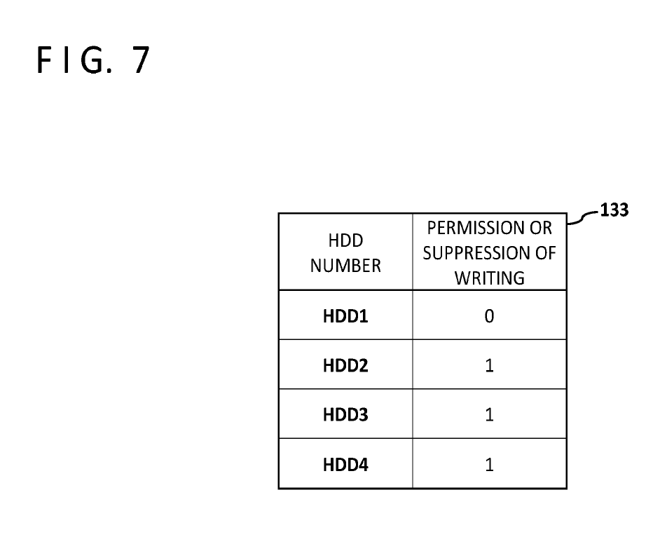

FIG. 7 is a view depicting an example of a configuration of a writable HDD table. The writable HDD table depicted in FIG. 7 may be the writable HDD table depicted in FIG. 2. The writable HDD table 133 is a table in which information for managing HDDs for which a writing process is to be performed and HDDs for which a reading out process is to be performed is stored, and is used in order to perform access control to the plurality of HDDs. For example, the data writing unit 113 specifies HDDs provided in the storage server 1 upon system initialization of the storage server 1 and adds the specified HDDs into a list of the writable HDD table 133 together with initial values of the writing permission/suppression information.

In the example of the writable HDD table 133 depicted in FIG. 7, the left column indicates HDD numbers (HDD 1 to HDD 4) of the HDDs 15 to 18, and the right column indicates values of a flag for permission or suppression of writing into a corresponding HDD. The flag for permission or suppression of writing indicates, for example, permission of writing by the value “1” thereof and suppression of writing or interruption of writing (during reading) by the value “0.”

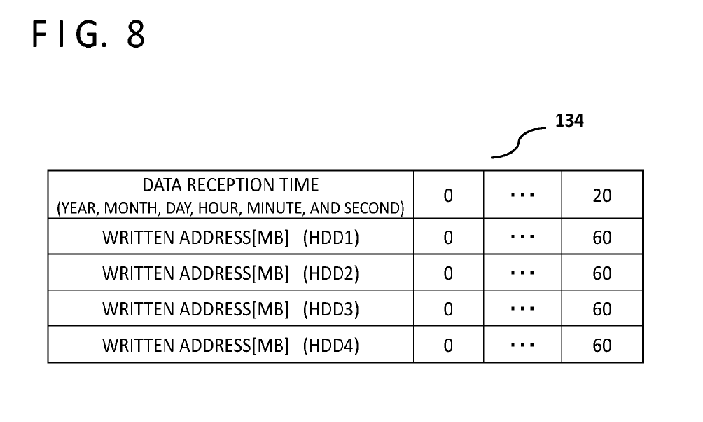

FIG. 8 is a view depicting an example of a configuration of a data management table. The data management table depicted in FIG. 8 may be the data management table 134 depicted in FIG. 2. The data management table 134 is a table for managing, for data obtained by dividing and storing stream data received in a chronological order into a plurality of HDDs, a storage address for each HDD (address in which data is written) and data reception time in an associated relationship with each other. Where HDDs for which a writing process is to be performed and HDDs for which a reading out process is to be performed are separated from each other as in the example of FIG. 6, since it is difficult for the HDDs for which a reading out process is being performed to write the data, the association between a storage address and a reception time of written data differs among different HDDs. Therefore, when a readout request for data written in a plurality of HDDs is received, the data reading out unit 114 executed by the CPU 11 refers to the storage address and the data reception time for each HDD stored in the data management table 134 to specify data to make a reading out target.

In the data management table 134 depicted in FIG. 8, the uppermost row indicates a timing (year, month, day, hour, minute and second) of data reception, and second and succeeding rows indicate write addresses of the individual HDDs. The data management table 134 is an example of data management information for managing a reception time of data to be stored into each HDD and a storage address of the data in an associated relationship with each other. In the example of the description of the data management table 134 of FIG. 8, the leftmost column indicates an item name, and on the right side of the leftmost column, information of the “data reception time” and address information of each HDD associated with the data reception time are represented in an associated relationship with each other in one column. FIG. 8 depicts an example of description not of a general description type of a list in a vertical direction but of a list of the data management table 134 of the description form of a list in which data are successively added in a horizontal direction for the convenience of illustration. Every time the divisional stream data outputted from the write buffer 131 are written into each HDD, a column including a reception time of the written data and a write address of the HDD is additionally written at the right side.

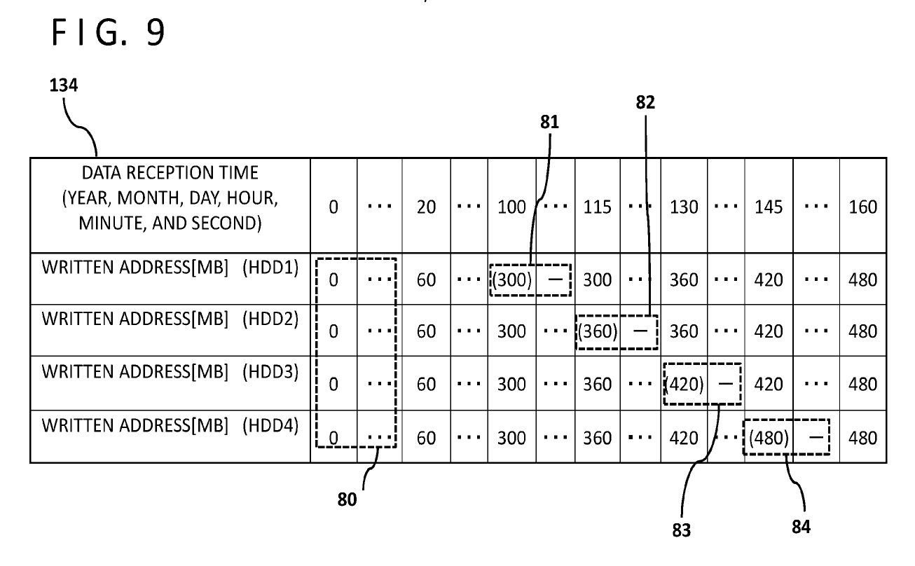

In FIG. 8, for simplified illustration, the time information is represented only by second, and states after starting of operation (zero seconds) till a point of time at which data received 20 seconds later are written into addresses up to the 60th address of the HDDs are depicted. Although a large number of writing processes into the HDDs are performed also within a period from the 0th second to the 20th second, the states in the writing processes are omitted by indicating them as “ . . . ” in the intermediate column in FIG. 8. Paying attention to FIG. 8 and a portion surrounded by a broken line frame 80 in FIG. 9, it is assumed that divisional data of a unity of units of five seconds represented by a column for the reception time of “0” and another column at the right side are successively written into each HDD. In FIG. 8, the “data reception time” in the uppermost row indicates a reception time of data stored in an HDD in which an address value is stored first when the values regarding the HDDs in the column are successively viewed in the downward direction. An associated relationship between data stored in each HDD and a reception time in the data management table 134 is hereinafter described with reference to FIG. 9.

It is to be noted that, if writing into an HDD is performed to the full capacity of the HDD, then rewriting is thereafter performed beginning with the top address, and therefore, information regarding the old data at the overwritten addresses may be deleted. Therefore, such a situation that data in the data management table 134 continues to increase infinitely does not occur.

The format in which address information and information of a data reception time are stored in the data management table 134 is not limited to the example of FIG. 8 and can be changed suitably. For example, a table in which address information and a data reception time are associated with each other for each HDD may be used. Alternatively, a storage table may be used in which information of a data reception time of each data, identification information of an HDD in which corresponding data is stored and address information in which the corresponding data is stored in the HDD are stored.

FIG. 9 depicts a state of a data management table when, after 100 seconds from starting of reception of stream data, a readout request for data within a period from the 0th second to a timing immediately before the 20th second is received and then the reading out operation is completed before 160 seconds from the starting of reception. The data management table depicted in FIG. 9 may be the data management table 134 depicted in FIG. 2.

For example, at a stage when stream data for 20 seconds received through the network 2 are written into the write buffer 131, the data division unit 112 executed by the CPU 11 partitions the stream data for the 20 seconds stored in the write buffer 131 for each five seconds to divide the stream data. The divisional data partitioned for each five seconds are data of a unit of a stripe upon writing into a plurality of HDDs by striping. Then, the data writing unit 113 executed by the CPU 11 writes the divisional data of a unit of a stripe partitioned for each five seconds into the four HDDs. It is to be noted that, while FIG. 9 depicts an example in which the four pieces of data of a unit of a stripe are written in parallel into four HDDs, the writing timings into the HDDs are not limited to such a form as just described. For example, at a stage at which data of one unit of a stripe (for example, stream data for five seconds) are stored into the write buffer 131, writing into one HDD that is a writing destination may be started.

In the example of FIG. 9, the top address of each HDD into which data is written when a unity of divisional data are written into the HDD is represented in such a form as “0,”“60” or “300.” In this case, in a region of the HDD 1 from the “0th” address to an address immediately preceding to the “60th” address, data within a period from the 0th to fourth second of the reception time (accurately, from the 0th second to a timing immediately before the 5th second). In the same address region of the HDD 2, data within a reception time period from the 5th to the ninth second (from the 5th to time immediate before the 10th second) are stored. Similarly, in the same address region of the HDD 3, data within a reception time period from the 10th second to the 14th second (from the 10th second to time immediately before the 15th second) are stored, and in the same address region of the HDD 4, data within a time period from the 15th second to the 19th second (from the 15th second to time immediate before the 20th second) are stored.

The data reading out unit 114 executed by the CPU 11 refers, when a readout request for data is received from the reading out client apparatus 4, to the data management table 134 to specify HDDs in which data of the reading out target are stored. In the example of the data management table 134 of FIG. 9, it is assumed that received data are written in a unit of five seconds into each HDD. Therefore, if a readout request for data within a period from the 0th second to the 19th second (from the 0th second to time immediately before the 20th second) is received, then the data reading out unit 114 refers to the data management table 134 to specify that the reading out target data are stored in the regions beginning with the “0th” address of each HDD.

After a plurality of HDDs including a storage region in which data of a target of a readout request are stored are specified, the data reading out unit 114 selects some HDD included in the specified plurality of HDDs and performs a reading out process for the selected HDD. In the example of FIG. 9, the data reading out unit 114 first selects the HDD 1 as a reading out target. Then, the data reading out unit 114 rewrites the information indicative of writing permission/suppression corresponding to the HDD 1 in the writable HDD table 133 from “1” to “0.” Thereafter, the data reading out unit 114 starts a reading out process from the HDD 1 after the data reading out unit 114 waits for the writing of data in a unit of a stripe into the HDD 1 to end. In the present embodiment, “interruption of a writing process” signifies that the writing process is interrupted at a stage at which writing of data of a unit of a stripe into the HDDs comes to an end.

In FIG. 9, a portion surrounded by the broken line frame 80 indicates data from the 0th second to time immediately before the 20th second which is a reading out target based on a readout request. In the reading out process, data within the period from the 0th second to the 4th second of the reception time written in the address following the “0th” address of the HDD 1 are read out from HDD 1 for a period of time after the 100th second to time immediately before the 115th second indicated by a broken line frame 81. Then, for a period of time from the 115th second to time immediately before the 130th second indicated by a broken line frame 82, data within a period from the 5th second to the 9th second of the reception time written in the address following the “0th” address of the HDD 2 are read out from the HDD 2.

Then, for a period of time from the 130th second to time immediately before the 145th second indicated by a broken line frame 83, data for a period from the 10th second to the 14th second of the reception time written in the addresses following the address “0” of the HDD 3 are read out from the HDD 3. Thereafter, for a period from the 145th second to time immediately before the 160th second indicated by a broken line frame 84, data within a period from the 15th second to the 19th second of the reception time written in the addresses following the address “0” of the HDD 4 are read out from the HDD 4.

In FIG. 9, “—” (horizontal bar) signifies that no writing has been performed in the time. Address values described in parentheses in the broken line frames 81 to 84 of FIG. 9 indicate address values when it is assumed that a writing process has been performed continuously without performing a reading out process as reference information, and information stored actually is “—.” For example, in FIG. 9, at a position of time of the 100th second of the HDD 1, actually writing has not been performed as yet, and therefore, the address value then is represented in parentheses, namely, as “(300).” It is to be noted that, in the data management table 134, the information of “—” may be some identification information representing that data has not been written.

Data read out from the HDDs by the data reading out unit 114 are stored once into the read buffer 132 of the memory 13. Then, the readout data stored in the read buffer 132 are reconstructed in a chronological order of the reception time by the data integration unit 115. The reply transmission unit 116 transmits the reconstructed data to the reading out client apparatus 4.

While the data reading out unit 114 is performing a reading out process within the period of the broken line frame 81, since it is difficult to write the data into the HDD 1, the write start address of the HDD 1 at the point of time of the 115th second is the 300th address into which the HDD 1 has been scheduled to start writing at the point of time of the 100th second. Similarly, in the HDD 2, the write start address at the point of time of the 130th second is the 360th address into which the HDD 2 has been scheduled to start writing at the point of time of the 115th second. This similarly applies also to the HDD 3 and the HDD 4.

It is to be noted that, in the present embodiment, while reading out is performed for one HDD, a writing process is performed for the remaining three HDDs. In the present embodiment, since the writing performance of each HDD is 4 [MB/s] that is one third of the maximum throughput 12 [MB/s] of received data, it is possible to write stream data into three HDDs without missing while a reading out process from one HDD is performed.

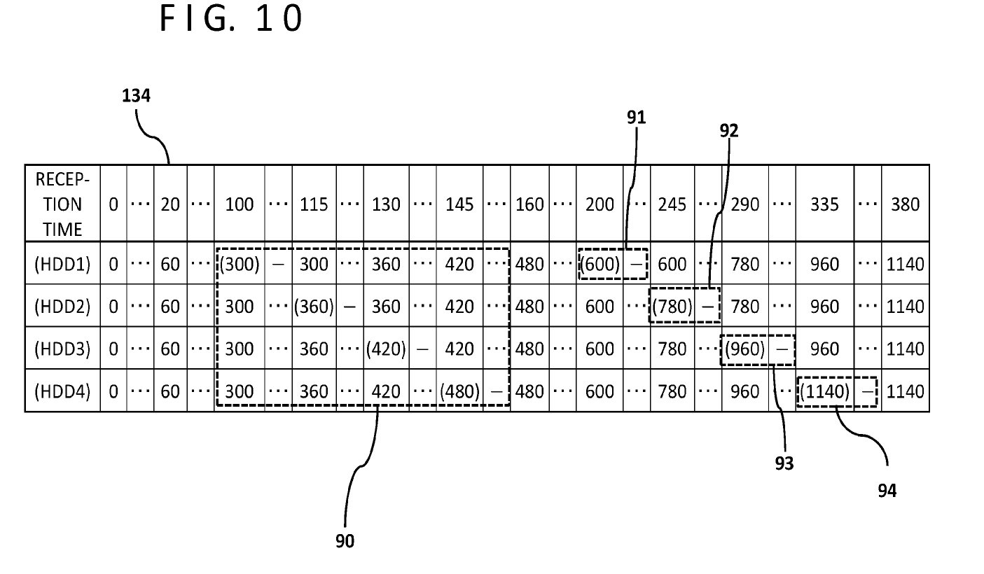

FIG. 10 is a view depicting a state of a data management table after a different reading out process is performed after the reading out process of FIG. 9. FIG. 10 depicts a state of the data management table 134 in a state in which a reading out operation is completed, after a readout request is received at the point of time of the 200th second for write data within a period from the 100th second to time immediately before the 160th second within which the reading out process has been performed in FIG. 9, before a point of time immediately before the 380th second.

In FIG. 10, a broken line frame 90 depicts data of a reading out target, and since the reading out process described hereinabove with reference to FIG. 9 has been performed, the reading out target data are stored divisionally in the three HDDs simultaneously in the time zones from the 100th second to time immediately before the 160th second. In particular, the data within the period from the 100th second to the time immediately before the 115th second are written in the three HDDs of the HDD 2 to the HDD 4. Similarly, the data within the period from the 115th second to the time immediately before the 130th second are written in the three HDDs of the HDD 1, the HDD 3 and the HDD 4. Similarly, the data within the period from the 130th second to the time immediately before the 145th second are written in the three HDDs of the HDD 1, the HDD 2 and the HDD 4, and the data within the period from the 145th second to the time immediately before the 160th second are written in the three HDDs of the HDD 1 to the HDD 3.

If a readout request for data in the region surrounded by the broken line frame 90 is received from the reading out client apparatus 4 at the point of time of the 200th second, then the data reading out unit 114 refers to the data management table 134 to specify a storage location of the data of the reading out target. In particular, the data reading out unit 114 first reads out and decides information in the column of the data management table 134 for the 100th second of the reception time from the HDDs in an ascending order of the HDD number beginning with the HDD 1.

Since the information of the field for the HDD 1 at the 100th second of the reception time is “—,” the data reading out unit 114 decides that data at the reception time of the 100th second are not stored in the HDD 1, and then decides information in the column of the HDD 2. Since the address value “300” is stored in the field of the HDD 2 in the column of the reception time of the 100th second, the data reading out unit 114 decides that the data at the reception time of the 100th second are stored in a region beginning of the address “300” of the HDD 2. As described hereinabove, since the examples of FIGS. 9 and 10 are depicted assuming that data in a unit of a stripe are assumed to be data for five seconds, the data reading out unit 114 decides whether data from the 105th second of the reception time are stored in the HDD 3. Since the address value “300” is stored also in the field for the HDD 3 in the column of the 100th second of the reception time in the data management table 134, the data reading out unit 114 decides that data at the 105th second of the reception time are stored in a region beginning of the address “300” of the HDD 3. Thereafter, the data reading out unit 114 similarly specifies the storage location of data of a reading out target of a readout request.

In the reading out process by the data reading out unit 114, data from the 300th address to an address immediately before the 480th address of the HDD 1 are read out for 45 seconds from the 200th second to time immediately before the 245th second as indicated by a broken line frame 91. The reading out process for the HDD 1 within the period of the broken line frame 91 corresponds to a reading out process of data within time periods from the 115th second to the 119th second, from the 130th second to the 134th second and from the 145th second to the 149th second of the reception time written in the HDD 1 within the period of the broken line frame 90.

Then, the data reading out unit 114 reads out data from the 300th address to the address immediately before the 480th address of the HDD 2 for 45 seconds from the 245th second to time immediately before the 290th second as indicated by a broken line frame 92. The reading out process for the HDD 2 within the period of the broken line frame 92 corresponds to a reading out process of data within time periods from the 100th second to the 104th second, from the 135th second to the 139th second and from the 150th second to the 154th second of the reception time, written in the HDD 2 within the period of the broken line frame 90.

Then, the data reading out unit 114 reads out data from the 300th address to the address immediately before the 480th address of the HDD 3 for 45 seconds from the 290th second to time immediately before the 335th second as indicated by a broken line frame 93. The reading out process for the HDD 3 within the period of the broken line frame 93 corresponds to a reading out process of data within time periods of the 105th second to the 109th second, from the 120th second to the 124th second and from the 155th second to the 159th second of the reception time, written in the HDD 3 within the period of the broken line frame 90.

Then, the data reading out unit 114 reads out data from the 300th address to the address immediately before the 480th address of the HDD 4 for 45 seconds from the 335th second to time immediately before the 380th second as indicated by a broken line frame 94. The reading out process for the HDD 4 within the period of the broken line frame 94 corresponds to a reading out process of data within time periods of from the 110th second to the 114th second, from the 125th second to the 129th second and from the 140th second to the 144th second of the reception time, written in the HDD 4 within the period of the broken line frame 90.

The readout data read out within the periods of the broken line frames 91 to 94 by the data reading out unit 114 are stored once into the read buffer 132 in the memory 13. Then, the readout data stored in the read buffer 132 are reconstructed in a chronological order of the reception time by the data integration unit 115. The reconstructed data within the period from the 100th second to the time immediately before the 160th second are transmitted to the reading out client apparatus 4 by the reply transmission unit 116.

If a readout request for data written in the plurality of HDDs in the past is received during a writing process into the plurality of HDDs, then in the present embodiment, part of the plurality of HDDs is selected as an HDD for reading out. While data of the reading out target are read out from the selected part of HDD for reading out, writing of stream data into the remaining HDDs is continued. Since, while writing of received data into the number of HDDs to be used to accumulate stream data without missing is continued, reading out from part of the HDDs is performed, it is possible to reduce the number of times of movement of a head of such disk apparatus as HDDs and improve the performance in the reading out process of the storage server.

In the example of the storage server 1 described above with reference to FIGS. 6 to 10, for simplified description, an example is described in which, when a writing process and a reading out process for the plurality of HDDs 15 to 18 are competitive, writing into one HDD is interrupted and a reading out process is performed only from the HDD whose writing is interrupted. However, in the case where the number of HDDs is greater or in the case where the writing performance of the HDDs is higher in rate, a surplus performance corresponding to a plurality of HDDs may possibly be generated in comparison with the flow rate of stream data. In this case, also it is possible to use a plurality of HDDs that are surplus for accumulation of stream data without missing as HDDs of a reading out target. Where a reading out process is performed simultaneously from the plurality of HDDs that are not to be used but are surplus for writing of stream data, the reading out process for a readout request can be completed at a higher speed.

Here, it is assumed that the number of HDDs included in the storage server is M and the number of HDDs except the number of HDDs necessary for accumulation of stream data without missing from among the M HDDs is N (M and N are natural numbers). In this case, if a readout request for data written in the past is received during writing of stream data into a plurality of HDDs included in the storage server, then a reading out process can be performed from the N HDDs while divisional stream data are written into the (M−N) HDDs.

Although the number N of surplus HDDs can be determined from a relationship between the flow rate of stream data and the writing performance of the HDDs, generally it can be roughly predicted upon system design of the storage server 1. Here, it is assumed that the maximum flow rate (bandwidth) of stream data that flow in the network 6 is B [MB/s], the number of HDDs is M, the maximum writing performance is b [MB/s], and the number of HDDs that can perform a reading out process simultaneously is N. In this case, only it is necessary for the system configuration of the storage server 1 to satisfy the condition of “B<=(M−N)*b,” and if the values of B, M and b are determined, then the value of N can be determined.

In a large-scale storage server, several tens to several hundreds HDDs are sometimes used, and in this case, even if a surplus performance of several % is estimated, it is possible to design the system such that a plurality of (N) HDDs can be assured so as to be used for a reading out process during data writing. It is to be noted that, if it is known that the maximum flow rate (bandwidth) of stream data varies, then the number N may be changed dynamically in accordance with the variation of the flow rate of the stream data.

Now, a program process for executing a writing process and a reading out process by the functional blocks (111 to 116) depicted in FIG. 3 is described with reference to a flow chart. A write request received from the writing client apparatus 3 is processed by the request reception unit 111, the data division unit 112 and the data writing unit 113. In particular, a process for accumulating the received data into the write buffer 131 in the memory 13, a process for dividing the data in the write buffer 131 into units of a stripe and a process for writing the divided data into the HDDs are performed by the processing units 111 to 113.

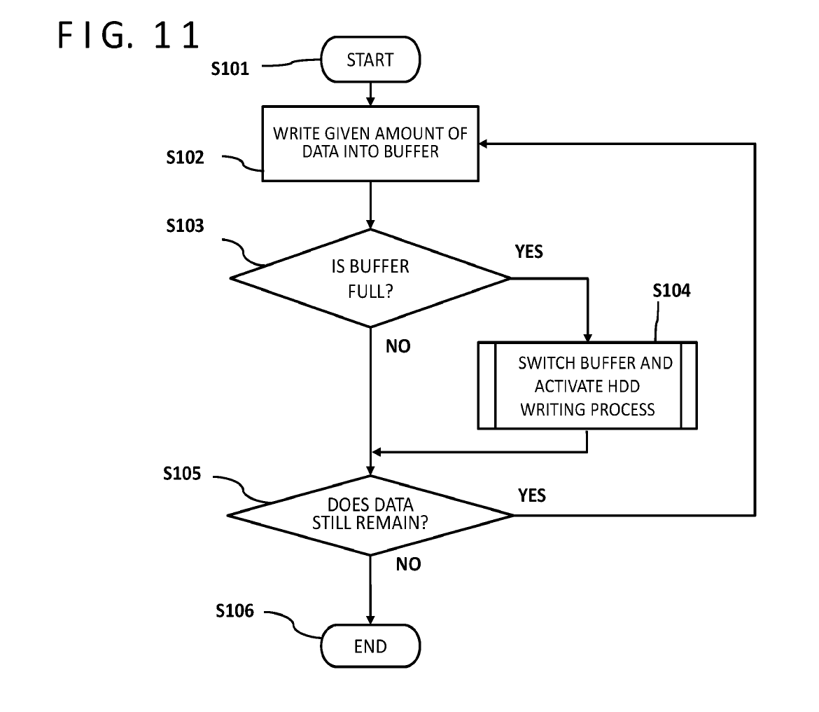

FIG. 11 is a flow chart of the process for accumulating, when a request reception unit receives a write request from a writing client apparatus, stream data received from a writing client apparatus into a write buffer. The request reception unit, the writing client apparatus, and the write buffer illustrated by reference to FIG. 11 may be the request reception unit 111 depicted in FIG. 3, the writing client apparatus 3 depicted in FIG. 1, and the write buffer 131 depicted in FIG. 2. At step S101, the flow of FIG. 11 is started, and the flow of FIG. 11 is activated every time the request reception unit 111 receives a write request from the writing client apparatus 3. At step S102, a process for writing a given amount of received stream data into the write buffer 131 is performed.

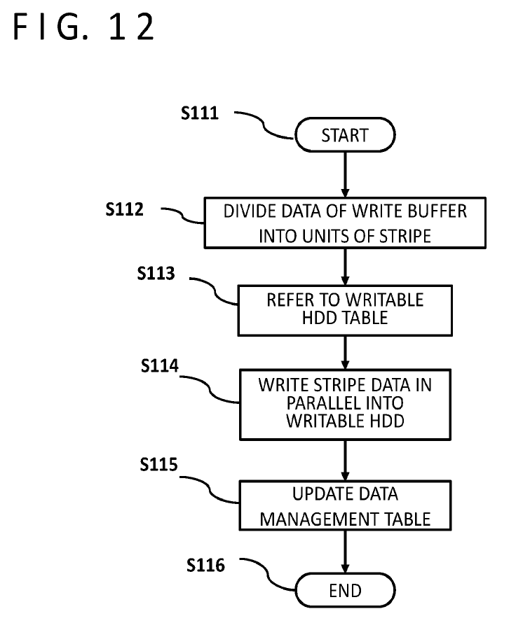

At step S103, it is decided whether or not the write buffer 131 is full or a given amount of data (for example, data of an amount which becomes a target for division in a unit of a stripe) are written in the write buffer 131. If the decision at step S103 is YES, then the request reception unit 111 switches the write buffer of the target of writing and activates a writing process into an HDD depicted in FIG. 12 (at step S104). It is to be noted that the write buffer 131 is formed as two write buffers of an equal capacity as depicted in FIG. 2. While stream data received from the writing client apparatus 3 are being accumulated into one of the write buffers 131, a writing process of data from the other write buffer 131 into an HDD is performed.

If the decision at step S103 is NO, then it is decided at step S105 whether or not data which has not been written into a write buffer still remains in the data of the received write request. If such data still remains (YES at step S105), then the processing returns to step S102. If it is decided at step S105 that writing of all data is completed (NO at step S105), then the processing is ended at step S106. The data amount by one write request is indefinite and may be smaller than the capacity of the write buffer 131. In this case, it is waited that data relating to a next write request arrive until the write buffer 131 is filled with data. On the contrary, if the writing client apparatus 3 transmits write data without taking the capacity of the write buffer 131 of the storage server 1 into consideration, then data exceeding the buffer capacity are sometimes received on the basis of one write request. Therefore, the decision process at step S105 is prepared.

If the write buffer 131 is full and does not allow writing all of received data, then the request reception unit 111 can issue a response to the writing client apparatus 3 of the transmission source of the write request to retry the write request. By the response, it is possible to store, after the data in the write buffer 131 are written into an HDD and a free space is generated in the write buffer 131, the data relating to the write request re-transmitted by the re-trial into the write buffer 131. It is to be noted that also it is possible to reduce the number of times of retrial by providing a certain margin to the capacity of the write buffer 131.

FIG. 12 is a flow chart of a process for writing data from a write buffer into HDDs from within a process for a request for writing. The write buffer illustrated by reference to FIG. 12 may be the write buffer 131 depicted in FIG. 2. The writing process is started at step S111 and is activated by the process at step S104 of FIG. 11 every time the write buffer 131 is filled with data. At step S112, the data division unit 112 divides the data stored in the write buffer 131 into data of a size of a unit of a stripe, which is a unit by which the data are divisionally written into a plurality of HDDs. Then at step S113, the data writing unit 113 refers to the writable HDD table 133 described hereinabove to confirm writable HDDs and determine those HDDs into which data are to be written.

After the HDDs of the writing destination of data are determined at step S113, the data writing unit 113 performs a writing process in a data unit of a strip in parallel into the writable HDDs (step S114). If writing of all of the data stored in the write buffer 131 into the plurality of HDDs comes to an end, then the data writing unit 113 updates the data management table 134 described hereinabove at step S115 and ends the processing at step S116.

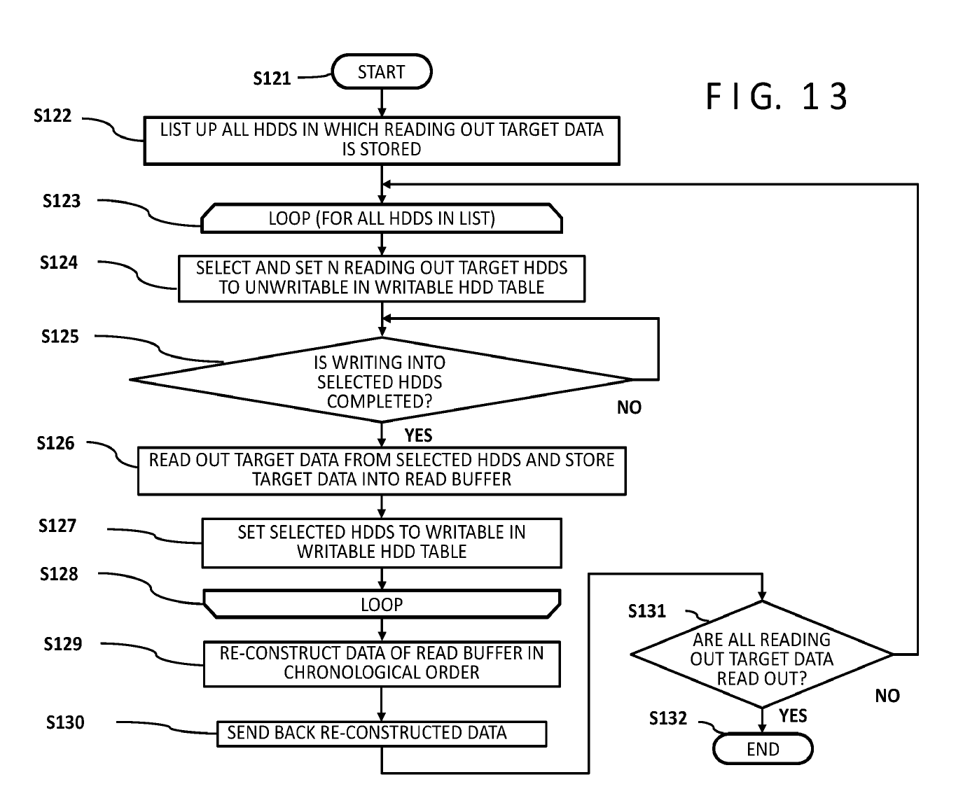

FIG. 13 depicts a processing flow when a request reception unit receives a readout request from a reading out client apparatus. The request reception unit and the reading out client apparatus illustrated in reference to FIG. 13 may be the request reception unit 111 depicted in FIG. 3 and the reading out client apparatus 4 depicted in FIG. 1, respectively. The flow starts at step S121 and is activated every time a readout request is received from the reading out client apparatus 4. If the request reception unit 111 receives a readout request, then the request reception unit 111 activates the data reading out unit 114. At step S122, the data reading out unit 114 refers to the data management table 134 to list up all HDDs in which data within a time range designated by the readout request are stored. The HDDs of a reading out target differ depending upon the size of data of the target of the readout request. For example, where four HDDs are available, if the size of data of a target of a readout request is smaller than the size of data of four stripes, then only part of the HDDs are used as a reading out target.

Then, the data reading out unit 114 repeats the processes from step S124 to step S127 in a loop from step S123 to step S128 for all of the listed up HDDs. Steps S123 and S128 signify that the processes between the steps are to be repeated. At step S124, N HDDs to be made a reading out target are selected from among the listed up HDDs. Then, for the N selected HDDs, the flag of the corresponding HDD number in the writable HDD table 133 is reset to zero to establish a writing suppression condition. In other words, the writing process of stream data into the selected HDD is interrupted. It is to be noted that the N HDDs of the reading out target may be selected arbitrarily only if the number of HDDs of a writing target into which stream data can be stored without missing can be secured, and a selection order may be determined in advance or may be selectively determined at random.

At step S125, it is decided whether or not the writing process that has been performed till the point of time for the N HDDs of the reading out target selected at step S124 is completed. If the writing process is being executed (NO at step S125), then it is waited that the writing process is completed. Since the writing process of FIG. 12 and the reading out process of FIG. 13 are performed asynchronously, it is waited at step S125 that the writing process in a unit of a stripe into the N HDDs selected as the reading out target comes to an end.

If the writing into the N selected HDDs is completed (YES at step S125), then the processing advances to step S126, at which a reading out process of the readout request target data from the N selected HDDs is performed and then the read out data are stored into the read buffer 132. If the reading out process from the N selected HDDs is completed, then the processing advances to step S127, at which the flag of the HDD in the writable HDD table 133 is returned to “1” and then an HDD which is to be made a next reading out target is selected. Thereafter, similar processes at the steps beginning with step S124 are repeated.

As regards the amount of data to be read out at step S126, where the capacity of the read buffer 132 is greater than the size of data that is made a reading out target of the readout request, it is possible to read out all data of the reading out target individually from the N HDDs. On the other hand, where the capacity of the read buffer 132 is smaller than the data size of the reading out target of the readout request, part of the data within a fixed range of reception time are read out from the N HDDs.

After data are read out from the HDDs of the entire reading out target into the read buffer 132 by the processes at steps S123 to S127, the data integration unit 115 reconstructs the data stored in the read buffer 132 into data of a chronological order at step S129. Then, the reply transmission unit 116 transmits the data reconstructed by the data integration unit 115 to the reading out client apparatus 4 (step S130). If all of the reading out target data based on the readout request are read out (YES at step S131), then the reading out process is completed (step S132).

If data that has not been read out from the plurality of HDDs remains from among the reading out target data of the readout request (NO at step S131), then the processing returns to step S123, and the processes at steps S123 to S130 are performed again for the data that has not been read out as yet. Thereafter, similar operation is repeated until all of the reading out target data are read out. In this case, until after all of the data of the reading out target are read out, the reply transmission unit 116 transmits the read out data to the reading out client apparatus 4 divisionally by a plural number of times or while temporarily placing wait time for a period of time until data to be transmitted are read out from an HDD.

As described above, with the working example disclosed herein, if a writing process and a reading out process into and from a plurality of HDDs are competitive in a storage server 1 that includes a plurality of disk storages such as plural HDDs, then the reading out process is performed from only part of the HDDs. By such reading out process, frequent movements of a magnetic head in the HDDs when the writing process and the reading out process into and from all HDDs are repeated alternately can be suppressed to the minimum.

When a writing process and a reading out process are switched for different addresses, a period of time is prepared such as seek time in which a head of an HDD moves, search time for waiting a magnetic disk to be rotated to a position at which data to be read out after the movement of the head is stored and so forth. The size of the write buffer 131 has an upper limit depending upon the limitation to the memory capacity and so forth, and it is assumed, for example, that the time for which data are to be accumulated into the write buffer 131 is 500 milliseconds. Further, it is assumed that the sum of the seek time and the search time of an HDD when switching from writing operation into reading out operation for the HDD is performed and then switching from the reading out operation back to the writing operation is performed is 50 milliseconds. In this case, if a currently available processing method of frequently performing switching between a writing process and a reading out process of all HDDs is applied, then time of 10% is taken every time the switching between writing operation and reading out operation is performed for each HDD.

It is assumed that, in a currently available processing method in which switching between a writing process and a reading out process for all HDDs is performed frequently, the four HDDs 15 to 18 of FIG. 5 are used and the flow rate of stream data is 12 [MB/s] while the maximum writing speed into the HDDs is 4 [MB/s]. In this case, when, while received data are written into the single write buffer 131, data stored in the other write buffer 131 are divided and written in a unit of a stripe into a plurality of HDDs, 375 milliseconds are taken for writing of data into the HDDs. In this instance, the time that can be used for a reading out process is 125 milliseconds. However, a period of 50 milliseconds from within 125 milliseconds is used for movement of a head and so forth, and the time that can be used for an actual reading out process is very short. In the method in which switching between a writing process and a reading out process which involve a movement of a head of an HDD is performed frequently for all HDDs, much time is used uselessly for the movement of the head, and the time that can be used for a reading out process is squeezed. Consequently, the speed of the reading out process is reduced.

In contrast, with the above-described technology disclosed herein, while a number of HDDS for a writing process prepared to accumulate stream data without missing are secured, frequent movements of a head for performing access can be suppressed by reading out data from part of the HDDs which is not performing a writing process. As a result, the reading out performance when writing and reading out of stream data are competitive in the storage server 1 can be improved.

While the preferred working example of the present embodiment has been described, the present embodiment is not limited to the particular working example but various modifications or alterations are possible. For example, when the data reading out unit 114 determines N HDDs that become a target of a reading out process to be executed by the data reading out unit 114, the number N of the HDDs that are to become a reading out target may be changed dynamically in response to the amount of reception per a fixed period of time of write data to be received from the writing client apparatus 3. Further, also with regard to the read buffer 132 as well as the write buffer 131, a plurality of regions may be provided such that a data transmission process to the reading out client apparatus 4 by the reply transmission unit 116 and a data reading out process from HDDs by the data reading out unit 114 may be performed in parallel to each other.

It is to be noted that a computer program that causes the CPU 11 to execute the functions of the functional blocks (111 to 116) depicted in FIG. 3 for controlling the storage server 1 described hereinabove and a non-temporary computer-readable recording medium on which the program is recorded are included in the scope of the present embodiment. Here, the non-temporary computer-readable recording medium is, for example, a memory card such as a secure digital (SD) memory card. It is to be noted that the computer program is not limited to that recorded on the recording medium but may be transmitted through an electric communication line, a wireless or wired communication line, a network represented by the Internet or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage apparatus, comprising:
a plurality of disk apparatuses;
a memory including a read buffer that is a region for temporarily storing data read out from the plurality of disk apparatuses; and
a processor coupled to the memory and configured to:
perform a writing process, the writing process including generating a plurality of pieces of divided data, which is obtained by dividing a series of received data, and writing the plurality of pieces of divided data into the plurality of disk apparatuses,
interrupt, when a readout request for reading out series of data from the plurality of disk apparatuses is received during execution of the writing process, the writing process to a predetermined number of disk apparatuses from among the plurality of disk apparatuses in which pieces of data requested by the readout request are stored,
read out the pieces of data requested by the readout request from the predetermined number of disk apparatuses with which the writing process is interrupted,
store the read out pieces of data into the read buffer,
reconstruct, after all pieces of the data requested by the readout request are stored into the read buffer, the pieces of data stored in the read buffer back into the series of data requested by the readout request, and
output the reconstructed data as a response to the readout request.

2. The storage apparatus according to claim 1, wherein the processor is configured to
while the pieces of data requested by the readout request are read out from the predetermined number of disk apparatuses, continuously perform the writing process of data into other disk apparatuses than the predetermined number of disk apparatuses among the plurality of disk apparatuses, and
after the reading out of the pieces of data requested by the readout request from the predetermined number of disk apparatuses is completed, restart the writing process of data into the predetermined number of disk apparatuses is restarted.

3. The storage apparatus according to claim 2, wherein the processor is configured to
change, when the reading out of the requested pieces of data divisionally stored in the predetermined number of disk apparatuses is completed, the disk apparatuses which are to interrupt the writing process and become a target for reading out of the requested pieces of data to the predetermined number of other disk apparatuses from among the plurality of disk apparatuses in which the pieces of data requested by the readout request are stored, and
perform reading out of the requested pieces of data from the predetermined number of other disk apparatuses.

4. The storage apparatus according to claim 1, wherein
the memory includes a write buffer that is a region for temporarily storing the series of received data, and
the processor is configured to
store the series of received data into the write butter,
divide, every time a given amount of data are stored into the write buffer, the data stored in the write buffer into the plurality of pieces of divided data, and
discretely write the plurality of pieces of divided data into the plurality of disk apparatuses.

5. The storage apparatus according to claim 1, wherein
the memory is configured to store data management information and write control information, the data management information indicating correspondence between address information of each of the disk apparatuses and pieces data stored in each of the disk apparatuses, the write control information being used to control whether writing of data into each disk apparatus is permitted or not, and
the processor is configured to
read out the pieces of data requested by the readout request based on the data management information, and
perform the writing process based on the write control information.

6. The storage apparatus according to claim 5, wherein the processor is configured to
specify, when the processor reads out the pieces of data requested by the readout request, a plurality of disk apparatuses in which the pieces of data requested by the readout request are stored by referring to the data management information,
sequentially select the predetermined number of disk apparatuses from among the specified disk apparatuses,
update the write control information corresponding to the selected predetermined number of disk apparatuses to information indicating that writing to a corresponding disk apparatus is suppressed, and
read out the pieces of data requested by the readout request from the selected predetermined number of disk apparatuses.

7. The storage apparatus according to claim 5, wherein the processor is configured to
when the writing process is to be performed, specify the plurality of disk apparatuses, into which writing is permitted, by referring to the write control information, and
perform the writing process to write the plurality of pieces of divided data into the specified disk apparatuses.

8. A method comprising:
performing, by a processor, a writing process, the writing process including generating a plurality of pieces of divided data, which is obtained by dividing a series of received data, and writing the plurality of pieces of divided data into the plurality of disk apparatuses;
interrupting, by the processor, when a readout request for reading out series of data from the plurality of disk apparatuses is received during execution of the writing process, the writing process to a predetermined number of disk apparatuses from among the plurality of disk apparatuses in which pieces of data requested by the readout request are stored;
reading out, by the processor, the pieces of data requested by the readout request from the predetermined number of disk apparatuses with which the writing process is interrupted;
storing, by the processor, the read out pieces of data into a read buffer included in a memory, the read buffer being a region for temporarily storing data read out from the plurality of disk apparatuses;
reconstructing, by the processor, after all pieces of the data requested by the readout request are stored into the read buffer, the pieces of data stored in the read buffer back into the series of data requested by the readout request; and
outputting by the processor, the reconstructed data as a response to the readout request.

9. The method according to claim 8, further comprising:
while the pieces of data requested by the readout request are read out from the predetermined number of disk apparatuses, continuously performing, by the processor, the writing process of data into other disk apparatuses than the predetermined number of disk apparatuses among the plurality of disk apparatuses; and
after the reading out of the pieces of data requested by the readout request from the predetermined number of disk apparatuses is completed, restarting the writing process of data into the predetermined number of disk apparatus is restarted by the processor.

10. The method according to claim 9, further comprising:
changing, by the processor, when the reading out of the requested pieces of data divisionally stored in the predetermined number of disk apparatuses is completed, the disk apparatuses which are to interrupt the writing process and become a target for reading out of the requested pieces of data to the predetermined number of other disk apparatuses from among the plurality of disk apparatuses in which the pieces of data requested by the readout request are stored; and
performing, by the processor, reading out of the requested pieces of data from the predetermined number of other disk apparatuses.

11. The method according to claim 8, further comprising:
storing, by the processor, the series of received data into the write butter in the memory, the write buffer being a region for temporarily storing the series of received data;
dividing, by the processor, every time a given amount of data are stored into the write buffer, the data stored in the write buffer into the plurality of pieces of divided data; and
discretely writing, by the processor, the plurality of pieces of divided data into the plurality of disk apparatuses.

12. The method according to claim 8, further comprising:
storing, by the processor, data management information and write control information in the memory, the data management information indicating correspondence between address information of each of the disk apparatuses and pieces data stored in each of the disk apparatuses, the write control information being used to control whether writing of data into each disk apparatus is permitted or not; and
reading out, by the processor, the pieces of data requested by the readout request based on the data management information, and
performing, by the processor, the writing process based on the write control information.

13. The method according to claim 12, further comprising:
specifying, by the processor, when the processor reads out the pieces of data requested by the readout request, a plurality of disk apparatuses in which the pieces of data requested by the readout request are stored by referring to the data management information;
sequentially selecting, by the processor, the predetermined number of disk apparatuses from among the specified disk apparatuses;
updating, by the processor, the write control information corresponding to the selected predetermined number of disk apparatuses to information indicating that writing to a corresponding disk apparatus is suppressed; and
reading out, by the processor, the pieces of data requested by the readout request from the selected predetermined number of disk apparatuses.

14. The method according to claim 12, further comprising:
when the writing process is to be performed, specifying the plurality of disk apparatuses, into which writing is permitted, by referring to the write control information; and
performing the writing process to write the plurality of pieces of divided data into the specified disk apparatuses.

15. A non-transitory computer readable medium having stored therein a program that causes a computer to execute a process, the process comprising:
performing a writing process, the writing process including generating a plurality of pieces of divided data, which is obtained by dividing a series of received data, and writing the plurality of pieces of divided data into the plurality of disk apparatuses;
interrupting, when a readout request for reading out series of data from the plurality of disk apparatuses is received during execution of the writing process, the writing process to a predetermined number of disk apparatuses from among the plurality of disk apparatuses in which pieces of data requested by the readout request are stored;
reading out the pieces of data requested by the readout request from the predetermined number of disk apparatuses with which the writing process is interrupted;
storing the read out pieces of data into a read buffer included in a memory, the read buffer being a region for temporarily storing data read out from the plurality of disk apparatuses;
reconstructing, after all pieces of the data requested by the readout request are stored into the read buffer, the pieces of data stored in the read buffer back into the series of data requested by the readout request; and
outputting the reconstructed data as a response to the readout request.

16. The non-transitory computer readable medium according to claim 15, wherein the process further comprising:
while the pieces of data requested by the readout request are read out from the predetermined number of disk apparatuses, continuously performing the writing process of data into other disk apparatuses than the predetermined number of disk apparatuses among the plurality of disk apparatuses; and
after the reading out of the pieces of data requested by the readout request from the predetermined number of disk apparatuses is completed, restarting the writing process of data into the predetermined number of disk apparatuses is restarted.

17. The non-transitory computer readable medium according to claim 16, wherein the process further comprising:
changing, when the reading out of the requested pieces of data divisionally stored in the predetermined number of disk apparatuses is completed, the disk apparatuses which are to interrupt the writing process and become a target for reading out of the requested pieces of data to the predetermined number of other disk apparatuses from among the plurality of disk apparatuses in which the pieces of data requested by the readout request are stored; and
performing reading out of the requested pieces of data from the predetermined number of other disk apparatuses.

18. The non-transitory computer readable medium according to claim 15, wherein the process further comprising:
storing the series of received data into the write butter in the memory, the write buffer being a region for temporarily storing the series of received data;
dividing, every time a given amount of data are stored into the write buffer, the data stored in the write buffer into the plurality of pieces of divided data; and
discretely writing the plurality of pieces of divided data into the plurality of disk apparatuses.

19. The non-transitory computer readable medium according to claim 15, wherein the process further comprising:
storing data management information and write control information in the memory, the data management information indicating correspondence between address information of each of the disk apparatuses and pieces data stored in each of the disk apparatuses, the write control information being used to control whether writing of data into each disk apparatus is permitted or not; and
reading out the pieces of data requested by the readout request based on the data management information, and
performing the writing process based on the write control information.

20. The non-transitory computer readable medium according to claim 19, wherein the process further comprising:
specifying, when the processor reads out the pieces of data requested by the readout request, a plurality of disk apparatuses in which the pieces of data requested by the readout request are stored by referring to the data management information;
sequentially selecting the predetermined number of disk apparatuses from among the specified disk apparatuses;
updating the write control information corresponding to the selected predetermined number of disk apparatuses to information indicating that writing to a corresponding disk apparatus is suppressed; and
reading out the pieces of data requested by the readout request from the selected predetermined number of disk apparatuses.
